(19) United States
(12) Patent Application Publication
(10) Pub. No.: US 2011/0209812 A1
(43) Pub. Date: Sep. 1, 2011

(54) METHOD OF MANUFACTURING COMPOSITE ARTICLE

(75) Inventors: Vishal Bansal, Overland Park, KS (US); Marni Loriel Rutkofsky, Raytown, MO (US)

(73) Assignee: GENERAL ELECTRIC COMPANY, Schenectady, NY (US)

(21) Appl. No.: 12/714,627

(22) Filed: Mar. 1, 2010

(51) Int. Cl. B32B 37/26; B32B 37/10

(52) U.S. Cl. 156/87

(57) ABSTRACT

A method of manufacturing a composite article such as an airplane part or a boat part is presented. The method includes: preparing a prepreg layup, the prepreg layup comprising a plurality of prepregs and at least one microporous breather membrane; enclosing the prepreg layup with a gas impermeable vacuum bag; evacuating a volume enclosed by the gas impermeable vacuum bag to preconsolidate the plurality of prepregs; consolidating the plurality of prepregs; and discontinuing the evacuating.

### BACKGROUND OF THE INVENTION

The invention relates generally to a method of manufacturing a composite article. More particularly, the invention relates to a method of manufacturing a composite article including but not limited to automotive parts, airplane parts, boat parts, helicopter parts, sports and leisure parts, and the like.

There is an interest in the benefits of composite materials and articles comprising them, and an interest in the applications of composite articles ranging from industrial, and sports and leisure to high performance aerospace components.

### BRIEF DESCRIPTION OF THE INVENTION

A first aspect of the disclosure provides a method of manufacturing a composite article, the method comprising: preparing a prepreg layup, the prepreg layup comprising a plurality of prepregs and at least one microporous breather membrane; enclosing the prepreg layup with a gas impermeable vacuum bag; evacuating a volume enclosed by the gas impermeable vacuum bag to preconsolidate the plurality of prepregs; consolidating the plurality of prepregs; and discontinuing the evacuating.

A second aspect of the disclosure provides a method of manufacturing a composite article, the method comprising: laying up a plurality of prepregs on a mold, wherein the mold has a shape of the composite article; overlaying the plurality of prepregs with a bleeder fabric; overlaying the bleeder fabric with at least one microporous breather membrane; enclosing the mold having the plurality of prepregs, the bleeder fabric, and the at least one microporous breather membrane with a gas impermeable vacuum bag; evacuating a volume enclosed by the gas impermeable vacuum bag to preconsolidate the plurality of prepregs; consolidating the plurality of prepregs; and discontinuing the evacuating.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a flow diagram of an embodiment of a method of manufacturing a composite article, in accordance with the present invention;

FIG. 2 shows a partial cross-section illustration of a vacuum bag lay-up of an embodiment of a method of manufacturing a composite article, in accordance with the present invention;

FIG. 3 shows a partial cross-section illustration of an embodiment of an oleophobic-treated expanded-fluoropolymer, in accordance with the present invention;

FIG. 4 shows an enlarged partial cross-section illustration of an embodiment of an oleophobic-treated expanded-fluoropolymer, in accordance with the present invention;

FIG. 5 shows a greatly enlarged cross-section illustration of a portion of an embodiment of an oleophobic-treated expanded-fluoropolymer, in accordance with the present invention;

FIG. 6 shows a scanning electron microscope (SEM) image of an embodiment of an expanded-fluoropolymer membrane prior to oleophobic treatment, in accordance with the present invention; and

FIG. 7 shows a SEM image of an embodiment of an expanded-fluoropolymer membrane after oleophobic treatment, in accordance with the present invention.

### DETAILED DESCRIPTION OF THE INVENTION

Current methods of manufacturing composite articles using prepregs generally comprise: laying up a plurality of prepregs on a suitable mold, each prepreg comprising reinforcing filaments enclosed in an uncured resin; overlaying the prepreg layers with a textile breather cloth; enclosing the laid up prepregs and the textile breather cloth with a gas impermeable vacuum bag; evacuating a volume enclosed by the vacuum bag and maintaining the prepregs at room temperature for a sufficient time to preconsolidate the prepregs; gradually increasing the temperature of the prepregs to a temperature which is high enough to cause the resin in the prepregs to become sufficiently mobile to permit the coalescing and molding of the prepregs to take place, and for the resin to subsequently gel (this step usually happens in an autoclave to provide consolidation of the prepregs); and reducing the temperature followed by discontinuing the evacuating and removing the resultant composite article formed from the mold.

The foregoing methods may not be entirely effective for producing composite articles of high quality and for high performance applications. During the manufacturing process, typically the textile breather cloth will become soaked by the resin and is no longer able to provide a path for volatile components of the resin to escape. Any volatile components and off-gasses present can result in the composite article having unwanted porosity therein.

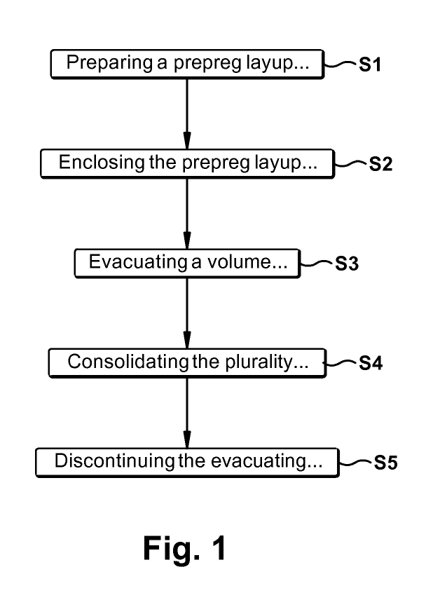

Referring to FIG. 1, an embodiment of a method of manufacturing a composite article is shown. The method comprises: a step S1, preparing a prepreg layup, the prepreg layup comprising a plurality of prepregs and at least one microporous breather membrane; a step S2, enclosing the prepreg layup with a gas impermeable vacuum bag; a step S3, evacuating a volume enclosed by the gas impermeable vacuum bag to preconsolidate the plurality of prepregs; a step S4, consolidating the plurality of prepregs; and a step S5, discontinuing the evacuating.

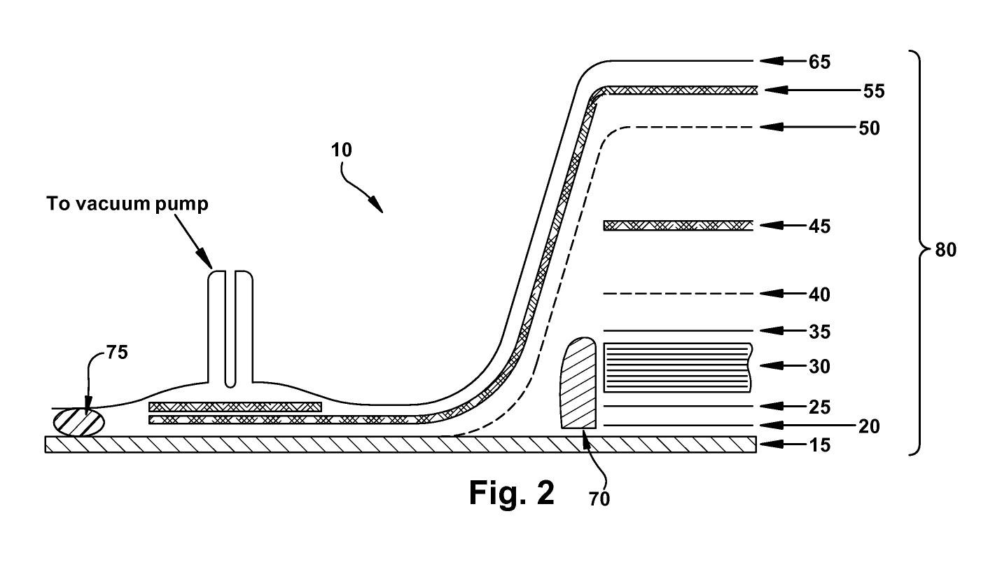

Referring to FIG. 2, a partial cross-section illustration of a vacuum bag lay-up 10 of an embodiment of a method of manufacturing a composite article is shown. Vacuum bag lay-up 10 is not shown in its entirety for the sake of clarity but one skilled in the art will recognize the structure of the entire vacuum bag lay-up 10 as described herein.

In an embodiment, vacuum bag layup 10 may comprise: a mold 15, a mold release agent 20, a first peel ply 25, a plurality of prepregs 30, a second peel ply 35, a first release film 40, a bleeder fabric 45, a second release film 50, a microporous breather membrane 55, a vacuum bag 65, an edge dam 70, and a seal 75. Mold release agent 20, first peel ply 25, plurality of prepregs 30, second peel ply 35, first release film 40, bleeder fabric 45, second release film 50, and microporous breather membrane 55, together form what may be referred to as a prepreg layup 80. Vacuum bag 65 sealed over prepreg layup 80 and mold 15 may be referred to as vacuum bag layup 10.

Referring to FIG. 1 and FIG. 2, an embodiment of a method for manufacturing a composite article is presented. Step S1, preparing a prepreg layup, mold 15 may be provided and selected in a shape of the composite article to be manufactured. In an embodiment, mold 15 may have a shape selected from the group consisting of automotive parts, airplane parts, helicopter parts, rail train parts, windmill parts, boat parts, parts for offshore oilfield platforms, aerospace parts, and sports and leisure parts. In another embodiment, the mold may have the shape selected from the group of airplane parts such as a nose cone, a landing gear flap, an engine casing, a slat, an aileron, an elevator, a rudder, a horizontal stabilizer, a vertical stabilizer, and a spoiler. In another embodiment, the mold may have the shape selected from the group of boat parts such as a deck and a hull. One having ordinary skill in the art will recognize that a mold of any part shape that is compatible with the process of laying up a plurality of prepregs to manufacture a composite article is encompassed by the method of the present invention. The process of laying up a plurality of prepregs on a mold described herein is well known in the art.

Mold 15 then may be coated with mold release agent 20 to allow easy removal of the composite article from mold 15 after the manufacturing method is completed. In an embodiment, mold release agent 20 may be applied with a brush, a cellulose pad, or an aerosol in a specially prepared room designed for vapor deposition. Mold release agent 20 may be overlaid with first peel ply 25. First peel ply 25 may allow free passage of volatiles and excess resin during the curing process described herein. First peel ply 25 may be removed to also provide a bondable and/or paintable surface of the composite article. Mold release agents, peel plys, and their use in composite article manufacturing processes are well known in the art.

Mold 15, mold release agent 20, and first peel ply 25 may be overlaid with plurality of prepregs 30. Plurality of prepregs 30 described herein may comprise a combination of a resin (or matrix) and a fiber reinforcement. In an embodiment, plurality of prepregs 30 may comprise at least one resin selected from the group consisting of an epoxy resin, a phenolic resin, and a polyimide resin.

In another embodiment, plurality of prepregs 30 may comprise at least one resin selected from the group consisting of tetraglycidyldiaminodiphenyl methane, bis(3,4-epoxy-6-methyl-cyclohexylmethyl)adipate, a novolak resin, and bismaleimide. Epoxy resins may include, for example, bisphenol A type resins obtained from bisphenol A and epichlorohydrin; resins obtained by epoxidation of novolak resins (produced from phenol and formaldehyde) with epichlorohydrin; polyfunctional epoxy resins such as tetraglycidyldiaminodiphenyl methane, etc., and alicyclic epoxy resins such as bis(3,4-epoxy-6-methyl-cyclohexylmethyl)adipate, etc.

Plurality of prepregs 30 may also comprise unsaturated polyester resins, for example, resins obtained by reacting a mixture of saturated dibasic acids such as orthophthalic acid or isophthalic acid, and unsaturated dibasic acids such as maleic acid anhydride or fumaric acid with diols such as propylene glycol, and resins produced by reacting bisphenol type or novolak type epoxy resins with methacrylic acid, etc. Phenolic resins may include, for example, novolak resins produced from phenol and formaldehyde, etc., and polyimide resins may include, for example, resins obtained by reacting bismaleimide with a diamine, etc.

The plurality of prepregs described herein for use in the method of the present invention are well known in the art. One having ordinary skill in the art will recognize that the exact number of prepregs used may be dependent on the desired characteristics of the composite article to be manufactured and can be determined without undue experimentation by one having ordinary skill in the art.

Plurality of prepregs 30 may then be overlaid with second peel ply 35 to allow free passage of volatiles and excess resin during the curing stage. Various embodiments and characteristics of a peel ply are described herein. First release film 40 may be applied to second peel ply 35. First release film 40 may aid in prevention of resin flow from plurality of prepregs 30 and may be slightly porous so as to allow the passage of air and volatiles. Release films and their use in the composite article manufacturing process are well known in the art.

Bleeder fabric 45 may then be overlaid on first release film 40 and may cover all the layers previously applied to mold 15. Bleeder fabric 40 may absorb excess resin and may help to regulate resin flow so as to produce the composite article having a known fiber volume. In an embodiment, the resin flow can be regulated by the quantity of bleeder fabric laid down to produce a composite article of known fiber volume. In another embodiment, bleeder fabric 40 described herein may be a felt of glass fabric. Bleeder fabric 40 described herein is well known in the art.

Second release film 50 may then be overlaid on bleeder fabric 40. Various embodiments and characteristics of a release film are described herein.

Microporous breather membrane 55 may be overlaid on second release film 50 having the underlying layers described herein. The process of overlaying various layers or membranes onto each other in a manufacturing process of a composite article using prepregs is well known in the art and thus, one having ordinary skill in the art will recognize how to overlay microporous breather membrane 55 described herein. One having ordinary skill in the art will recognize that more than one microporous breather membrane 55 described herein may be used in the method described herein. In an embodiment, microporous breather membrane 55 may have a minimum air permeability value of 0.005 cubic feet per minute/square foot at 0.5 inches of H₂O. In another embodiment, microporous breather membrane 55 may be laminated with a textile fabric so as to improve handling of microporous breather membrane 55 during the manufacturing process.

Microporous breather membrane 55 may comprise an expanded (e)-fluoropolymer including but not limited to e-poly(tetrafluoroethylene). In an embodiment, the e-poly(tetrafluoroethylene) may be oleophobically treated. Various characteristics, embodiments, and methods of forming the oleophobically-treated e-poly(tetrafluoroethylene) membrane are described in U.S. Pat. No. 6,228,477 ('477), which is hereby incorporated by reference in its entirety. For the sake of clarity and convenience, certain passages from '477 are described herein. From here-on-in, microporous breather membrane 55 will be referred to as oleophobically-treated e-fluoropolymer membrane 55 unless specifically stated otherwise.

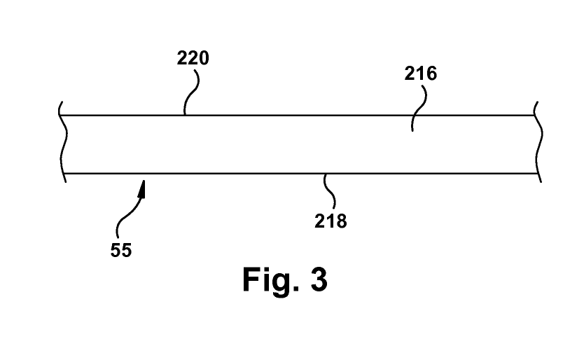

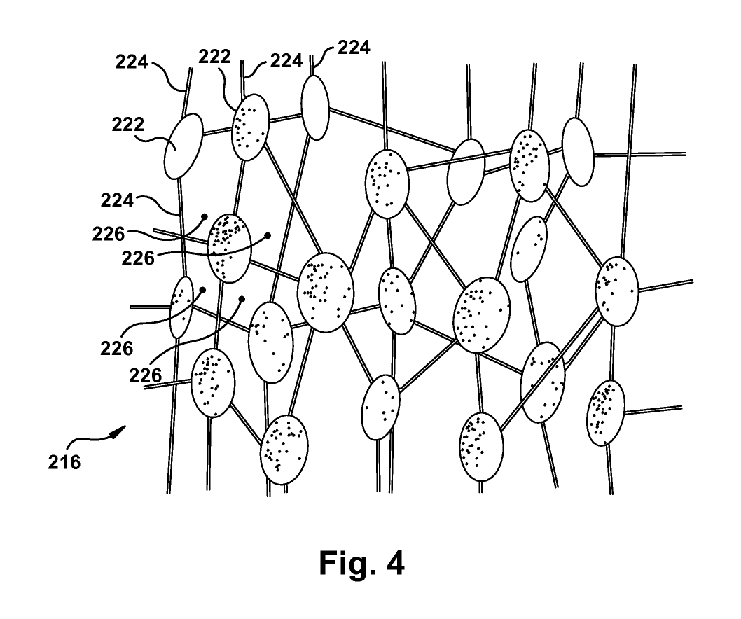

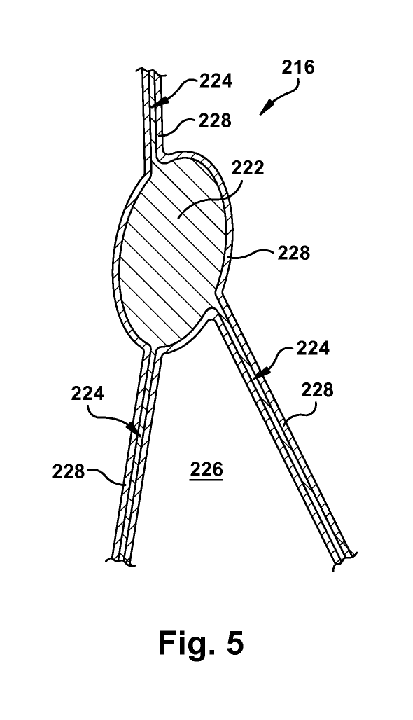

Referring to FIGS. 3, 4, and 5, oleophobically-treated e-fluoropolymer breather membrane 55 comprises a membrane 216 and a coating 228. Membrane 216 also comprises opposite major sides 218 and 220. Membrane 216 may be porous and may have a three-dimensional matrix or lattice type structure having numerous nodes 222 interconnected by numerous fibrils 224. In an embodiment, membrane 216 may be microporous. In another embodiment, membrane 216 may comprise expanded (e)-poly(tetrafluoroethylene) (e-PTFE).

One having ordinary skill in the art will recognize that any membrane made from a material that may be oleophobic or treated to be as such is encompassed by the method of the present invention. One having ordinary skill in the art will also recognize that any fluoropolymer membrane that may be oleophobic or treated to be as such is encompassed by the method of the present invention. The surfaces of nodes 222 and fibrils 224 may define numerous interconnecting pores 226 that extend through membrane 216 between major opposite sides 218 and 220. Membrane 216 may be coated with an oleophobic fluoropolymer material in such a way that enhanced oleophobic and hydrophobic properties result without compromising its air permeability.

Coating 228 may adhere to nodes 222 and fibrils 224 that define pores 226 in membrane 216. Coating 228 may also conform to the surfaces of most of nodes 222 and fibrils 224. Coating 228 may improve the oleophobicity of membrane 216 by resisting contamination from absorbing of contaminating materials such as oils, body oils in perspiration, fatty substances, detergent-like surfactants, resins, and other contaminating agents.

The physical definition of “wetting” is based on the concepts of surface energy and surface tension. Liquid molecules are attracted to one another at their surfaces. This attraction tends to pull the liquid molecules together. Relatively high values of surface tension mean that the molecules have a strong attraction to one another and it is relatively more difficult to separate the molecules. The attraction varies depending on the type of molecule. For example, water has a relatively high surface tension value because the attraction in water molecules is relatively high due to hydrogen bonding. Fluorinated polymers or fluoropolymers have a relatively low surface tension value because of the strong electronegativity of the fluorine atom.

Membrane 216 made from e-PTFE may contain many small interconnected capillary-like pores 226 that fluidly communicate with environments adjacent to opposite major sides 218 and 220 of membrane 226. Therefore, the propensity of the e-PTFE material of membrane 216 to adsorb a challenge liquid, as well as whether a challenge liquid would be adsorbed into pores 226, is a function of the surface energy of the solid, the surface tension of the liquid, the relative contact angle between the liquid and solid, and the size or flow area of the capillary-like pores.

Substantially improved oleophobic properties of membrane 216 may be realized if the surfaces defining pores 226 in membrane 216, and major opposite sides 218 and 220 are coated with an oleophobic fluoropolymer. A water dispersion of oleophobic fluoropolymer resin or solids may be capable of wetting membrane 216 and entering pores 226 of membrane 216 when diluted by a water-miscible wetting agent, for example isopropyl alcohol (IPA). The diluted dispersion of oleophobic fluoropolymer has a surface tension and relative contact angle that permit the diluted dispersion to wet and be drawn into pores 226 of membrane 216. The minimum amount of wetting agent that may be required for the blend to enter pores 226 in membrane 216 depends on the surface tension of the diluted dispersion and the relative contact angle between the diluted dispersion and the material of membrane 216. The minimum amount of wetting agent may be determined without undue experimentation by adding drops of different blend ratios to the surface of membrane 216 and observing which concentrations are immediately drawn into pores 226 of membrane 216.

To prevent or minimize the loss of resistance to liquid penetration in an e-PTFE membrane 216, the value of the surface energy of membrane 216 may be lower than the value of the surface tension of the challenge liquid and the relative contact angle may be more than 90°.

The use of a coalesced oleophobic fluoropolymer, such as an acrylic-based polymer with fluorocarbon side chains, to coat membrane 216 may reduce the surface energy of membrane 216 so fewer liquids are capable of wetting membrane 216 and enter pores 226. The acrylic-based polymer with fluorocarbon side chains that may be used to coat membrane 216 may be in the form of a water-miscible dispersion of perfluoroalkyl acrylic copolymer dispersed primarily in water, but may also contain relatively small amounts of acetone and ethylene glycol or other water-miscible solvents. Coating 228 may be disposed on and around surfaces of nodes 222 and fibrils 224 that define interconnecting pores 226 extending through membrane 216. Coating 228 may enhance the hydrophobic properties of membrane 216 in addition to providing better oleophobic properties to membrane 216.

Oleophobically-treated e-fluoropolymer membrane 55 may have a relatively high moisture vapor transmission rate (MVTR) and air permeability. In an embodiment, oleophobically-treated e-fluoropolymer membrane 55 may have a moisture vapor transmission rate (MVTR) of at least 1000 g/m² per 24 hrs. In another embodiment, oleophobically-treated e-fluoropolymer membrane 55 may have a MVTR of at least 1500 g/m² per 24 hrs.

Membrane 216 may be made by extruding a mixture of PTFE (available from du Pont under the name TEFLON®) particles and lubricant. The extrudate may then be calendered. The calendered extrudate is then expanded or stretched to form fibrils connecting the particles or nodes in a three dimensional matrix or lattice structure. Expanded is meant to connote sufficiently stretched beyond the elastic limit of the material to introduce permanent set or elongation to the fibrils of the material being stretched.

Other materials and methods may be used to form a suitable porous membrane 216 that has pores 226 extending through membrane 216. For example, other suitable materials include a polyolefin, a polyamide, a polyester, a polysulfone, a polyether, an acrylic and a methacrylic polymer, a polystyrene, a polyurethane, a polypropylene, a polyethylene, a cellulosic polymer, and combinations thereof.

Surfaces of nodes 222 and fibrils 224 define a plurality of interconnected pores 226 that may be in fluid communication with one another and may extend through membrane 216 between opposite sides 218 and 220 of membrane 216. In an embodiment, a suitable size for pores 226 may be in a range of approximately 0.3 microns to approximately 10 microns. In another embodiment, the size of pores 226 may be the range of approximately 1.0 micron to approximately 5.0 microns. Membrane 216 may then be heated to reduce and minimize residual stress. In an embodiment, membrane 216 may be unsintered, partially sintered, or fully sintered.

After the e-PTFE membrane 216 is manufactured, the diluted dispersion of the oleophobic fluoropolymer may be applied to membrane 216 to wet the surfaces of nodes 222 and fibrils 224 that define pores 226. The thickness of oleophobic fluoropolymer coating 228, and the amount and type of fluoropolymer solids in coating 228 may depend on several factors. These factors include the affinity of the solids to adhere and conform to the surfaces of nodes 222 and fibrils 224. After the wetting operation, substantially all of the surfaces of nodes 222 and fibrils 224 may be at least partially wetted, and in another embodiment, all the surfaces of all nodes 222 and fibrils 224 may be completely wetted without completely blocking pores 226 in membrane 216.

It is not necessary that coating 228 completely encapsulate the entire surface of nodes 222 or fibrils 224, or be continuous to increase oleophobicity of membrane 216. In an embodiment, coating 228 may completely encapsulate the entire surface of nodes 222 or fibrils 224, or may be continuous. The finished coating 228 may result from coalescing the oleophobic fluoropolymer solids, for example in an aqueous dispersion of acrylic-based polymer with fluorocarbon side chains diluted in a water-miscible wetting agent, on as many of the surfaces of membrane 216 as possible.

The oleophobic fluoropolymer solids of the diluted dispersion may engage and may adhere to surfaces of nodes 222 and fibrils 224 that define pores 226 after the wetting agent material is removed. The oleophobic fluoropolymer solids may be heated on membrane 216 to coalesce and thereby render oleophobic-treated e-fluoropolymer membrane 216 resistant to contamination by absorbing oils and contaminating agents. During the application of heat, the thermal mobility of the oleophobic fluoropolymer solids may allow the solids to flow around nodes 222 and fibrils 224, and form coating 228. The fluorocarbon side chains may be oriented to extend in a direction away from the coated surface of nodes 222 or fibrils 224. The coalesced oleophobic fluoropolymer may provide a relatively thin protective coating 228 on membrane 216 that does not completely block or blind pores 226 in oleophobically-treated e-fluoropolymer membrane 55. Oleophobically-treated e-fluoropolymer membrane 55 may also have improved Z-strength, that is oleophobically-treated e-fluoropolymer membrane 55 may resist separating into distinct layers when a force is applied in a direction normal to major sides 18 and 20.

The aqueous dispersion of acrylic-based polymer with fluorocarbon side chains may include water, a perfluoroalkyl acrylic copolymer, a water soluble co-solvent, and a glycol. One having ordinary skill in the art would recognize without undue experimentation other solvents, co-solvents, and surfactants that may also comprise the aqueous dispersion. In an embodiment, a family of acrylic-based polymer with fluorocarbon side chains that may be used in the aqueous dispersion is the Zonyl® family of fluorine containing dispersion polymers (made by du Pont and available from CIBA Specialty Chemicals). In another embodiment, Zonyl® 7040 may be used in the aqueous dispersion. Other commercially available chemicals that may be used in the aqueous dispersion are Milliken's Millguard®, Elf Atochem Foraperle®, Asahi Glass and Chemical's Asahi Guard®, Repearl™ 8040 (available from Mistubishi), and 3Ms Scotchgard® and Scotchban® products.

The dispersion of the acrylic-based polymer having fluorocarbon side chains may be diluted in a wetting agent or solvent, such as ethanol, isopropyl alcohol, methanol, n-propanol, n-butanol, N—N-dimethylformamide, methyl ethyl ketone, and water soluble e- and p-series glycol ethers. The dispersion may be diluted to provide a ratio by weight of wetting agent to dispersion in the range of approximately 1:5 to approximately 20:1. In another embodiment, the ratio may be in a range from approximately 3:1 to approximately 9:1. An amount of oleophobic fluo-ropolymer solid in the Zonyl® 7040 aqueous dispersion may be up to 20 weight (wt) %, and in another embodiment, a range of approximately 14 wt % to approximately 18 wt %.

The diluted dispersion may contain oleophobic fluoropolymer solids in a range of approximately 1.0 wt % to approximately 10.0 wt %. In an embodiment, the range may be approximately 2.0 wt % to approximately 6.0 wt %. The resulting diluted dispersion has surface tension relative contact angle properties that enable the diluted dispersion to wet pores 226 in membrane 216 and ultimately, be coated with oleophobic fluoropolymer solids. The average particle size of the oleophobic fluoropolymer solids may be approximately 0.15 microns.

An embodiment of a method of treating membrane 216 is presented herein. The method includes providing membrane 216 having surfaces defining a plurality of pores 226 extending through membrane 216. In an embodiment, the pores 226 in membrane 216 may be microporous. In another embodiment, membrane 216 may be made from e-PTFE. Membrane 216 may be unreeled from a roll, and trained over rollers and directed into a holding tank or a reservoir over an immersion roller. A diluted dispersion of water-miscible acrylic-based polymer with fluorocarbon side chains may be in the reservoir.

The dispersion of acrylic-based polymer with fluorocarbon side chains may then be diluted in a suitable wetting agent, such as isopropyl alcohol or acetone. The dispersion of acrylic-based polymer with fluorocarbon side chains may be diluted at a ratio of water-miscible wetting agent to the dispersion of acrylic-based polymer with fluorocarbon side chains in a range of approximately 1:5 to approximately 20:1. In an embodiment, the ratio may be approximately 3:1 to approximately 9:1. The diluted dispersion may then be applied to membrane 216 by any suitable method known in the art, for example, by roll coating, immersion (dipping), spraying, and the like. The diluted dispersion may impregnate membrane 216, wet the surfaces of nodes 222 and fibrils 224 that define pores 226, and the surfaces of major sides 18 and 20

The undiluted dispersion may have a surface tension and relative contact angle so it may not wet pores 226. The diluted dispersion may contain perfluoroalkyl acrylic copolymer solids in ethylene glycol and water diluted in a wetting agent, such as isopropyl alcohol, at a predetermined ratio. The diluted dispersion may have a surface tension and relative contact angle such that the diluted dispersion can wet all surfaces of membrane 216. As membrane 216 is immersed in the diluted dispersion, surfaces of membrane 216 that define pores 226 may be engaged, wetted, and coated by the diluted dispersion. The wetted membrane 216 may then be directed out of the reservoir.

A mechanism, such as a pair of squeegees or doctor blades, may engage opposite major sides 218 and 220 of wetted membrane 216. The doctor blades of the mechanism may spread the diluted dispersion and may remove excess diluted dispersion from wetted membrane 216 to minimize the chance of blocking pores in membrane 216. Any other suitable means for removing the excess diluted dispersion may be used, such as an air knife.

Wetted membrane 216 may exit the doctor blade mechanism. Wetted membrane 216 may then be trained over rollers. The wetting agent and any other fugitive materials, such as water, acetone and ethylene glycol in the diluted dispersion, may be subsequently removed by air drying or other drying methods. The wetting agent typically evaporates by itself but the evaporation may be accelerated by applying relatively low heat, for example, approximately 100° C. when isopropyl alcohol is the wetting agent. Wetting agent vapor may move away from the wetted membrane 216.

Wetted membrane 216 may then be directed to an oven with heat. It may be necessary to enclose or vent the reservoir and heat sources with a hood. The hood may be vented to a desired location through a conduit. The hood may remove and capture the vapor, such as, fugitive wetting agent and emulsifiers, from wetted membrane 216 and may direct the captured material to a location for storage or disposal. The heat sources may each have two heating zones. The first zone may be a “drying zone” to apply relatively low heat to wetted membrane 216, for example 100° C., to evaporate any fugitive wetting agents that have not yet evaporated. The second zone may be a “curing zone” to coalesce the oleophobic fluoropolymer solids.

The heat sources may apply heat at a temperature of at least 140° C. for at least approximately thirty seconds to wetted membrane 216. The applied heat may coalesce the oleophobic fluoropolymer solids in the acrylic-based polymer with fluorocarbon side chains onto and around the surfaces of nodes 222 and fibrils 226 to render the oleophobic-treated e-fluoropolymer membrane 55 oil and contaminating agent resistant. The amount and duration that the heat is applied to treat membrane 216 may allows solids to coalesce and flow while the fluorocarbon side chains orient and extend in a direction away from the surfaces of nodes 222 and fibrils 226 that are coated. Oleophobic-treated e-fluoropolymer membrane 55 may then exit the heat sources and may then be trained over rollers and directed onto a take up reel.

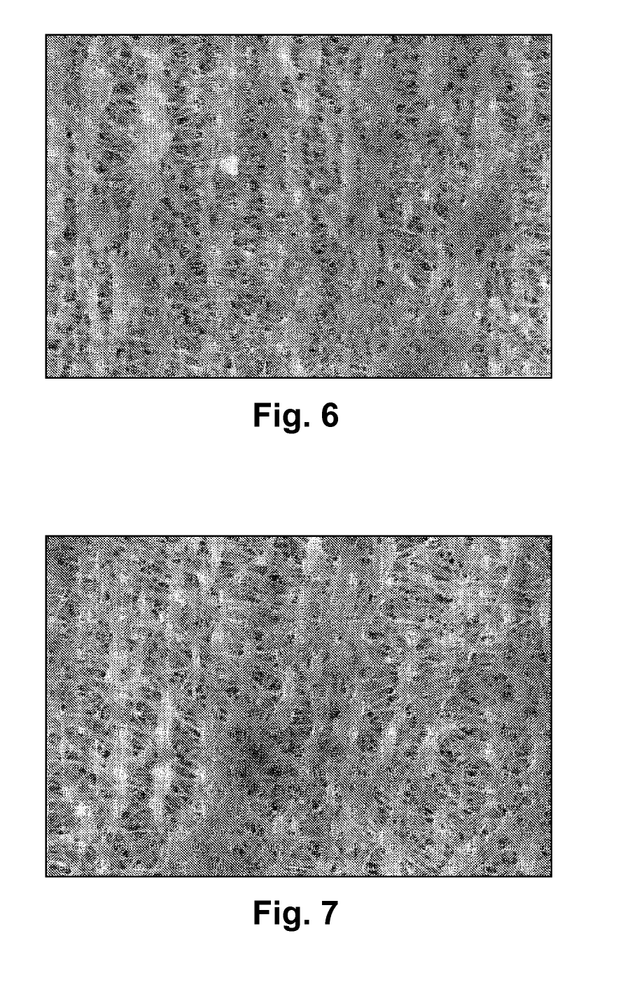

Referring to FIG. 6, a scanning electron microscope (SEM) photograph of an embodiment of uncoated membrane 216 is shown. For comparison purposes, an embodiment of an oleophobic-treated e-PTFE membrane 55 is shown in FIG. 7. Referring to FIGS. 6 and 7, oleophobic-treated e-PTFE membrane 55 includes the same uncoated membrane 216 with coating 228 applied. Membranes 216 (FIG. 6) and 55 (FIG. 7) are from the same production run. The SEMs are at the same magnification and it can be seen that coated fibrils 224 of FIG. 7 have a thicker appearance due to the layer of coating 228 on fibrils 224 but pores 226 in oleophobic-treated e-PTFE membrane 55 are not completely blocked. The air permeability of oleophobic-treated e-PTFE membrane 55 illustrated in FIG. 7 was 1.21 cubic feet per minute (CFM) per square foot as measured by a Frazier Air Permeability Tester.

Oleophobically-treated e-polyfluoropolymer membrane 55 may have an advantage over typically used poly(propylene) membranes in that the oleophobically-treated e-polyfluoropolymer membrane 55 may be used in high temperature cure processes in excess of 200° C. Oleophobically-treated e-polyfluoropolymer membrane 55 may also present an advantage in that the characteristics of oleophobically-treated e-polyfluoropolymer membrane 55 may enable manufacturing at temperatures up to and including 300° C. Oleophobically-treated e-polyfluoropolymer membrane 55 may further enable manufacturing at temperatures in a range from approximately 80° C. to approximately 300° C. and all subranges therebetween.

Oleophobically-treated e-polyfluoropolymer membrane 55 may have an advantage of resisting wetting/leakage of crosslinkers from the resins of plurality of prepregs 30. The crosslinkers may have surface tensions as low as 15 dynes/cm. In an embodiment, oleophobically-treated e-fluoropolymer membrane 55 may be disposable.

It has been discovered that an advantage that may be realized in the practice of some embodiments of a method of manufacturing a composite article described herein is that when an oleophobically-treated expanded (e)-fluoropolymer membrane 55 is used, oleophobically-treated e-fluoropolymer membrane 55 is capable of maintaining a continuous breathable path for the volatiles generated to escape; subsequently leading to reduced porosity in the composite article manufactured.

Referring back to the term microporous breather membrane 55, it may be manufactured by the aforementioned methodology or by other techniques known in the art including but not limited to the use of supercritical fluids, vapor phase deposition, and etc.

In an embodiment of the method of the present invention, the method may additionally comprise overlaying a textile breather cloth known in the art on oleophobically-treated e-polyfluoropolymer membrane 55. The textile breather cloth may additionally allow for the application of a vacuum and may additionally assist in the removal of air, volatiles, and offgasses from the whole assembly. One having ordinary skill in the art will recognize without any undue experimentation that the thickness of the breather cloth needed for use in the manufacturing method described herein is dependent on the application, i.e., the composite article to be manufactured. The process of overlaying a breather cloth on a previously laid down layer in a manufacturing process of a composite article using prepregs is well known in the art.

Returning to FIGS. 1 and 2, after preparing prepreg layup 80 in step S1, it may then be enclosed with a gas impermeable vacuum bag 65 in step S2. Vacuum bag 65 may be sealed with seal 75. Air may then be evacuated forcing vacuum bag 65 down onto prepreg layup 80 causing prepreg layup 80 to be preconsolidated in step S3. The process of enclosing a mold having a plurality of prepregs and various layers thereon with a gas impermeable vacuum bag, and evacuating the volume enclosed by the impermeable vacuum bag is well known in the art.

In step S4, plurality of prepregs 30 may be consolidated. Vacuum bag lay-up 10 having a vacuum still applied may be placed inside an oven, not shown, and heat may be applied in a controlled manner to cause plurality of prepregs 30 of prepreg layup 80 to coalesce and mold to the shape of the composite article. Heating in a controlled manner may avoid large temperature differentials between the air temperature and plurality of prepregs 30. In an embodiment, vacuum bag lay-up 10 having a vacuum still applied may be placed inside an autoclave.

Consolidating may additionally comprise curing the coalesced and molded plurality of prepregs. In an embodiment, the curing may be performed in an oven. In another embodiment, the curing may be performed in an autoclave. The process of curing a coalesced and molded plurality of prepregs is well known in the art. In an embodiment, consolidating and curing plurality of prepregs 30 may not need to be conducted in autoclave or may be conducted in an autoclave at a reduced pressure as some of the vertical compression may be provided by the applied vacuum itself due to the use of microporous breather membrane 55 or multiple microporous breather membranes.

It has been discovered that an advantage that may be realized in the practice of some embodiments of a method of manufacturing a composite article described herein is that when microporous breather membrane 55 is used, a continuous vertical compression is able to be applied over the entire surface of the prepregs during the resin curing step; subsequently leading to improved dimensional tolerances on the non-tools side of the composite article.

Consolidating may also additionally comprise cooling the cured plurality of prepregs 30 in a controlled manner so as to avoid sudden temperature drops which may induce high thermal stresses. In an embodiment, the cooling may be performed in an oven. In another embodiment, the cooling may be performed in an autoclave. The pressure and/or vacuum may be maintained throughout the cooling period. The process of cooling the plurality of prepregs 30 in a controlled manner is well known in the art.

In step S5, after consolidation, the vacuum may be discontinued and then the composite article, may be removed from mold 15.

It has been discovered that an advantage that may be realized in the practice of some embodiments of a method of manufacturing a composite article described herein is that when microporous breather membrane 55 is used, a reduction of porosity of the composite article may be achieved due to the continuous removal of volatile components and off gassing.

It has been discovered that another advantage that may be realized in the practice of some embodiments of a method of manufacturing a composite article described herein is that when microporous breather membrane 55 is used, a better uniform thickness of the composite article may be achieved due to the reduced porosity of the composite article.

It has been discovered that another advantage that may be realized in the practice of some embodiments of a method of manufacturing a composite article described herein is that when microporous breather membrane 55 is used, a reduction of resin usage and less resin waste may be achieved since the resin does not soak microporous breather membrane 55.

The benefits and advantages of using microporous breather membrane 55 described herein may apply when microporous breather membrane 55 is used in conjunction with traditional textile breather cloth described herein or in the absence of the textile breather cloth.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “approximately” used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to approximately 25 wt %, or, more specifically, approximately 5 wt % to approximately 20 wt %”, is inclusive of the endpoints and all intermediate values of the ranges of “approximately 5 wt % to approximately 25 wt %,” etc).

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of manufacturing a composite article, the method comprising:
preparing a prepreg layup, the prepreg layup comprising a plurality of prepregs and at least one microporous breather membrane;
enclosing the prepreg layup with a gas impermeable vacuum bag;
evacuating a volume enclosed by the gas impermeable vacuum bag to preconsolidate the plurality of prepregs;
consolidating the plurality of prepregs; and
discontinuing the evacuating.

2. A method of manufacturing a composite article according to claim 1, wherein the plurality of prepregs comprise at least one resin selected from the group consisting of an epoxy resin, a phenolic resin, and a polyimide resin.

3. A method of manufacturing a composite article according to claim 2, wherein the at least one resin is selected from the group consisting of tetraglycidyldiaminodiphenyl methane, bis(3,4-epoxy-6-methyl-cyclohexylmethyl)adipate, a novolak resin, and bismaleimide.

4. A method of manufacturing a composite article according to claim 1, wherein the at least one microporous membrane comprises expanded (e)-poly(tetrafluoroethylene).

5. A method of manufacturing a composite article according to claim 4, wherein the at least one microporous breather membrane comprises oleophobically-treated (e)-poly(tetrafluoroethylene).

6. A method of manufacturing a composite article according to claim 5, wherein the at least one microporous breather membrane comprises (e)-poly(tetrafluoroethylene) having a coating thereon comprising an acrylic-based polymer with fluorocarbon side chains.

7. A method of manufacturing a composite article according to claim 1, wherein preparing the prepreg layup comprises: laying up the plurality of prepregs on a mold, wherein the mold has a shape of the composite article; overlaying the plurality of prepregs with a bleeder fabric; and overlaying the bleeder fabric with the at least one microporous breather membrane.

8. A method of manufacturing a composite article according to claim 7, additionally comprising applying a mold release agent to the mold.

9. A method of manufacturing a composite article according to claim 8, additionally comprising overlaying the mold release agent with a first peel ply.

10. A method of manufacturing a composite article according to claim 7, additionally comprising overlaying the plurality of prepregs with a second peel ply.

11. A method of manufacturing a composite article according to claim 10, additionally comprising overlaying the second peel ply with a first release film.

12. A method of manufacturing a composite article according to claim 7, additionally comprising overlaying the bleeder fabric with a second release film.

13. A method of manufacturing a composite article according to claim 1, wherein the consolidating comprises: applying heat in a controlled manner to the plurality of prepregs so as to cause the plurality of prepregs to coalesce and mold to the shape of the composite article; curing the coalesced and molded plurality of prepregs; and cooling the cured plurality of prepregs in a controlled manner.

14. A method of manufacturing a composite article according to claim 1, wherein the at least one microporous breather membrane has a minimum air permeability value of 0.005 cubic feet per minute/feet at 0.5 inches of H₂O.

15. A method of manufacturing a composite article according to claim 1, wherein the at least one microporous breather membrane is laminated to a textile fabric.

16. A method of manufacturing a composite article, the method comprising:
laying up a plurality of prepregs on a mold, wherein the mold has a shape of the composite article;
overlaying the plurality of prepregs with a bleeder fabric;
overlaying the bleeder fabric with at least one microporous breather membrane;
enclosing the mold having the plurality of prepregs, the bleeder fabric, and the at least one microporous breather membrane with a gas impermeable vacuum bag;
evacuating a volume enclosed by the gas impermeable vacuum bag to preconsolidate the plurality of prepregs;
consolidating the plurality of prepregs; and
discontinuing the evacuating.

17. A method of manufacturing a composite article according to claim 16, wherein the plurality of prepregs comprise at least one resin selected from the group consisting of an epoxy resin, a phenolic resin, and a polyimide resin.

18. A method of manufacturing a composite article according to claim 17, wherein the at least one resin is selected from the group consisting of bis(3,4-epoxy-6-methyl-cyclohexylmethyl)adipate, and a bismaleimide.

19. A method of manufacturing a composite article according to claim 16, wherein the at least one microporous breather membrane comprises oleophobically-treated (e)-poly(tetrafluoroethylene).

20. A method of manufacturing a composite article according to claim 16, wherein the at least one microporous breather membrane is laminated to a textile fabric.
